(19) United States
(12) Patent Application Publication
(10) Pub. No.: US 2007/0005881 A1
(43) Pub. Date: Jan. 4, 2007

(54) Minimizing memory bandwidth usage in optimal disk transfers

(76) Inventor: John I. Garney, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,062

(22) Filed: Jun. 30, 2005

(51) Int. Cl. G06F 12/00

(52) U.S. Cl. 711/112

(57) ABSTRACT

In some embodiments, a method to minimize memory bandwidth usage in optimal disk transfers is presented. In this regard, a transfer agent is introduced to read a plurality of contiguous sections of a mass storage device in a single operation, and to transfer data from fewer than all the sections read. Other embodiments are also disclosed and claimed.

### FIELD OF THE INVENTION

Embodiments of the present invention generally relate to the field of data transfers, and, more particularly to minimizing memory bandwidth usage in optimal disk transfers.

### BACKGROUND OF THE INVENTION

Modern processors, such as computer microprocessors, can process data much faster than previously possible, however the inefficient transfer of data between storage devices, memory devices and processors can slow down the performance of an electronic appliance, such as a computer.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing the transfer agent, in accordance with one example embodiment of the invention;

FIG. 2 is a block diagram of an example transfer agent architecture, in accordance with one example embodiment of the invention;

FIG. 3 is a flow chart of an example method to minimize memory bandwidth usage in optimal disk transfers, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

FIG. 1 is a block diagram of an example electronic appliance suitable for implementing the transfer agent, in accordance with one example embodiment of the invention. Electronic appliance 100 is intended to represent any of a wide variety of traditional and non-traditional electronic appliances, laptops, desktops, servers, disk drives, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, transfer agent 106, system memory 108, expansion controller 110, storage device 112 and input/output device(s) 114 coupled as shown in FIG. 1. Transfer agent 106, as described more fully hereinafter, may well be used in electronic appliances of greater or lesser complexity than that depicted in FIG. 1. Also, the innovative attributes of transfer agent 106 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 108 with the other components of electronic appliance 100. In one embodiment, the connection between processor(s) 102 and memory controller 104 may be referred to as a front-side bus. In another embodiment, memory controller 104 may be referred to as a north bridge.

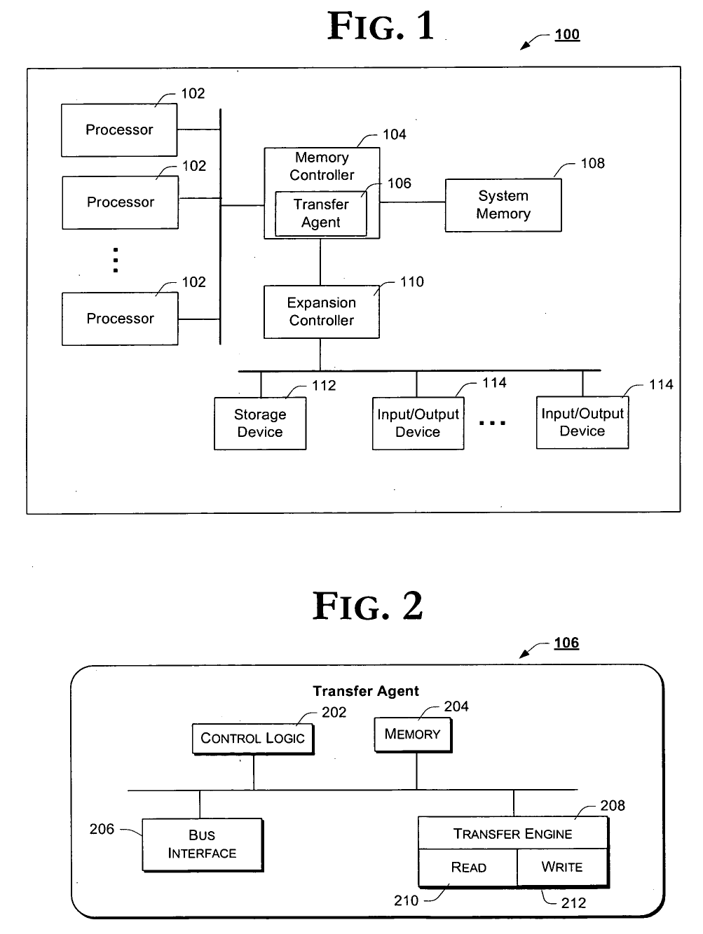

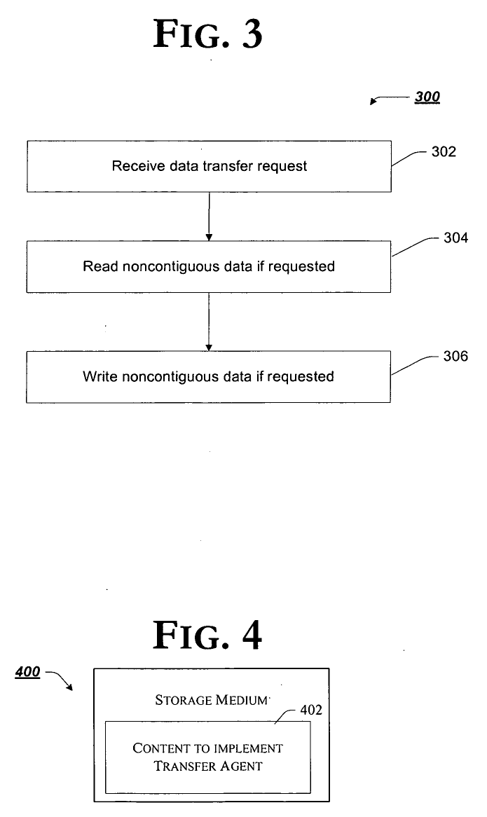

Transfer agent 106 may have an architecture as described in greater detail with reference to FIG. 2. Transfer agent 106 may also perform one or more methods to minimize memory bandwidth usage in optimal disk transfers, such as the method described in greater detail with reference to FIG. 3. While shown as being a part of memory controller 104, transfer agent 106 may well be part of another component, for example expansion controller 110 or storage device 112, or may be implemented in software, as part of a driver or operating system, or a combination of hardware and software.

System memory 108 may represent any type of memory device(s) used to store data and instructions that may have been or will be used by processor(s) 102. Typically, though the invention is not limited in this respect, system memory 108 will consist of dynamic random access memory (DRAM). In one embodiment, system memory 108 may consist of Rambus DRAM (RDRAM). In another embodiment, system memory 108 may consist of double data rate synchronous DRAM (DDRSDRAM).

Expansion controller 110 may represent any type of chipset or control logic that interfaces expansion devices with the other components of electronic appliance 100. In one embodiment, expansion controller 110 may be referred to as a south bridge. In one embodiment, expansion controller 110 complies with Peripheral Component Interconnect (PCI) Express Base Specification, Revision 1.0, PCI Special Interest Group, released Apr. 29, 2002.

Storage device 112 may represent any storage device used for the long term storage of data. In one embodiment, storage device 112 may be a hard disk drive comprising a plurality of sectors. In a hard disk drive with a spinning disk, there may be a delay associated with commencing each read or write operation. Storage device 112 may contain operating systems and applications, which may comprise various executable, data and library files.

Input/output (I/O) device(s) 114 may represent any type of device, peripheral or component that provides input to or processes output from electronic appliance 100. In one embodiment, though the present invention is not so limited, an I/O device 114 may be a network interface controller.

FIG. 2 is a block diagram of an example transfer agent architecture, in accordance with one example embodiment of the invention. As shown, transfer agent 106 may include one or more of control logic 202, memory 204, bus interface 206, and transfer engine 208 coupled as shown in FIG. 2. In accordance with one aspect of the present invention, to be developed more fully below, transfer agent 106 may include a transfer engine 208 comprising one or more of read services 210 and/or write services 212. It is to be appreciated that, although depicted as a number of disparate functional blocks, one or more of elements 202-214 may well be combined into one or more multi-functional blocks. Similarly, transfer engine 208 may well be practiced with fewer functional blocks, i.e., with only read services 210, without deviating from the spirit and scope of the present invention, and may well be implemented in hardware, software, firmware, or any combination thereof. In this regard, transfer agent 106 in general and transfer engine 208 in particular are merely illustrative of one example implementation of one aspect of the present invention. As used herein, transfer agent 106 may well be embodied in hardware, software, firmware and/or any combination thereof. For example, transfer agent 106 may be implemented completely in software as a disk-driver, a storage controller driver, a RAID controller driver, a file-system driver, or a filter driver anywhere in the storage driver hierarchy.

Transfer agent 106 may have the ability to minimize memory bandwidth usage in optimal disk transfers. In one embodiment, transfer agent 106 may read a plurality of contiguous sections of a mass storage device in a single operation, and transfer data from fewer than all the sections read. In another embodiment, transfer agent 106 may receive data from a memory, and write the data to noncontiguous sections of a mass storage device in a single write operation. One skilled in the art would recognize that through this method efficiencies can be gained in data transmission and write latency where some portions of data needed are resident in memory and others need to be retrieved.

As used herein control logic 202 provides the logical interface between transfer agent 106 and its host electronic appliance 100. In this regard, control logic 202 may manage one or more aspects of transfer agent 106 to provide a communication interface from electronic appliance 100 to software, firmware and the like, e.g., instructions being executed by processor(s) 102.

According to one aspect of the present invention, though the claims are not so limited, control logic 202 may receive event indications such as, e.g., a data transfer request. Upon receiving such an indication, control logic 202 may selectively invoke the resource(s) of transfer engine 208. As part of an example method to minimize memory bandwidth usage in optimal disk transfers, as explained in greater detail with reference to FIG. 3, control logic 202 may selectively invoke read services 210 that may read noncontiguous data. Control logic 202 also may selectively invoke write services 212, as explained in greater detail with reference to FIG. 3, to write noncontiguous data. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. In one embodiment, memory 204 may be a dedicated portion of system memory 108. In another embodiment, memory 204 may be part of a processor, system disk, or network cache. Memory 204 may also be used to store data or instructions for effectuating a data transfer, for example.

Bus interface 206 provides a path through which transfer agent 106 can communicate with other components of electronic appliance 100, for example storage device 112 or system memory 108. In one embodiment, bus interface 206 may represent a PCI Express interface.

Read services 210, as introduced above, may provide transfer agent 106 with the ability to read data from a source device such as storage device 112. In one example embodiment, read services 210 may translate a scatter/gather list requesting noncontiguous data from storage device 112, into a single read operation whereby more data is read than requested. The single read operation can be composed of ranges of desired data and ranges that of data that is not desired. Each range can be identified as representing desired data or not. This identification can be accomplished with a bit per range. The desired data ranges will be transferred from the storage device 112 to system memory 108. The undesired data ranges will not be transferred. The single read operation advances through locations on the storage device 112 whether the data is desired or not. In this way, read services 210 may optimize the access time of data from storage device 112 by combining the reading of noncontiguous data into a single read operation that spans the range of multiple requested data sets.

Write services 212, as introduced above, may provide transfer agent 106 with the ability to write transmitted data. In one embodiment, write services 212 may translate a scatter/gather list requesting noncontiguous data transferred to storage device 112 into a single write operation whereby less data is written than requested. In another embodiment, when writing to storage device 112, write services 212 may identify for each range whether the data located at corresponding locations on the storage device 112 is perturbed or not. This identification can utilize an additional bit of information in the request. Ranges, possibly sectors, identified as unperturbed will not be modified. Range identified as perturbed will be written. This allows writing data to noncontiguous portions on either side of an unperturbed portion, so as to write the overall data in a single operation.

FIG. 3 is a flow chart of an example method for minimizing memory bandwidth usage in optimal disk transfers, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with control logic 202 receiving (302) a data transfer request. In one example embodiment, the request may be scatter/gather request to read data from noncontiguous portions of storage device 112. In another embodiment, the request may be to write data to noncontiguous portions of storage device 112.

In the case of a read request, control logic 202 may then selectively invoke read services 210 to read (304) noncontiguous data. In one example embodiment, read services 210 reads a range of data on storage device 112 that spans the locations of the data requested and also includes the data between the noncontiguous data locations. In one embodiment, the data that is transferred to system memory 108 only includes the data that is requested and not already resident in memory, namely the data between the noncontiguous requested data locations.

In the case of a write request, write services 212 may write (306) noncontiguous data. In one embodiment, write services 212 writes data intended for noncontiguous portions of storage device 112 by addressing a range of data that spans the locations of the target addresses and includes the locations between the noncontiguous destinations. In another embodiment, write services 212 utilizes of bit of information to leave unperturbed those locations in the address range to which no data is to be written.

FIG. 4 illustrates a block diagram of an example storage medium comprising content which, when accessed, causes an electronic appliance to implement one or more aspects of the transfer agent 106 and/or associated method 300. In this regard, storage medium 400 includes content 402 (e.g., instructions, data, or any combination thereof) which, when executed, causes the appliance to implement one or more aspects of transfer agent 106, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), disk drives, computers, among other electronic components. However, it should be understood that the scope of the present invention is not limited to these examples.

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
reading a plurality of contiguous sections of a mass storage device in a single operation; and
transferring data from fewer than all the sections read.

2. The method of claim 1, wherein the sections of the mass storage device comprise disk sectors of a hard drive.

3. The method of claim 1, further comprising:
receiving a request for noncontiguous data as part of a scatter/gather list.

4. The method of claim 1, further comprising:
utilizing a bit of information to determine whether to transfer data read.

5. The method of claim 1, further comprising:
writing the transferred data into noncontiguous portions of system memory.

6. The method of claim 1, wherein transferring data from fewer than all sections read comprises not transferring data that is already resident in system memory.

7. An electronic appliance, comprising:
a processor;
a memory coupled with the processor;
a storage device coupled with the memory; and
a transfer engine coupled with the memory, the transfer engine to read a plurality of contiguous sections of a mass storage device in a single operation, and to transfer data from fewer than all the sections read.

8. The electronic appliance of claim 7, wherein the storage device comprises a hard drive.

9. The electronic appliance of claim 7, further comprising:
the transfer engine to utilize a bit of information to affect whether data read is transferred.

10. The electronic appliance of claim 7, further comprising:
the transfer engine to submit a request for noncontiguous data as part of a scatter/gather list.

11. The electronic appliance of claim 7, further comprising:
the transfer engine to write the transferred data into noncontiguous portions of the memory.

12. The electronic appliance of claim 7, wherein the transfer engine to transfer data from fewer than all the sections read comprises the transfer engine to transfer data read except for data already stored in the memory.

13. A storage medium comprising content which, when executed by an accessing machine, causes the accessing machine to read a plurality of contiguous sections of a hard disk drive in a single read operation, and to transfer data from fewer than all the sections read.

14. The storage medium of claim 13, further comprising content which, when executed by the accessing machine, causes the accessing machine to operate on a request received for noncontiguous data as part of a scatter/gather list.

15. The storage medium of claim 13, further comprising content which, when executed by the accessing machine, causes the accessing machine to not transfer data that is already resident in system memory.

16. The storage medium of claim 13, further comprising content which, when executed by the accessing machine, causes the accessing machine to utilize a bit of information in determining whether to transfer data read.

17. The storage medium of claim 13, further comprising content which, when executed by the accessing machine, causes the accessing machine to write the transferred data into noncontiguous portions of system memory.

18. A method, comprising:
receiving data from a memory; and
writing the data to noncontiguous sections of a mass storage device in a single write operation.

19. The method of claim 18, wherein the sections of the mass storage device comprise disk sectors of a hard drive.

20. The method of claim 18, further comprising receiving a request to write data to noncontiguous sections of the mass storage device as part of a scatter/gather list.

21. The method of claim 18, further comprising utilizing a bit of information to determine whether to perturb sections of the mass storage device.

22. The method of claim 18, further comprising receiving the data from noncontiguous portions of system memory.
